(19) United States
(12) Patent Application Publication
(10) Pub. No.: US 2026/0220079 A1
(43) Pub. Date: Jul. 30, 2026

(54) FIELD-BASED LIGHT COMPUTING WITHOUT STORED TOPOLOGY AND METHODS OF DECODING RESULTING FIELD STATES

(71) Applicant: Anil P. Rami, MOUNDSVILLE, WV (US)

(72) Inventor: Anil P. Rami, MOUNDSVILLE, WV (US)

(21) Appl. No.: 19/452,222

(22) Filed: Jan. 16, 2026

(51) Int. Cl. G06F 15/78

(52) U.S. Cl. CPC G06F 15/7867

(57) ABSTRACT

A computing architecture is disclosed in which information processing arises from transient physical field evolution within a medium that lacks stored routing topology. Computational behavior is not encoded in fabricated paths, waveguides, or ports, but instead emerges dynamically from physical laws governing the field and the medium. Computational paths exist only during propagation and are not retained as state. Outputs are determined by measurement and interpretation of resulting field states rather than predefined endpoints. The architecture decouples computation and decoding from lithographic structure, enabling scalable, reconfigurable computation governed by sensing, geometry, and physical limits.

### CROSS-REFERENCE TO RELATED APPLICATIONS

This application claims priority to U.S. Provisional Ser. No. 63/961,365, filed Jan. 15, 2026, the entire contents of which are incorporated herein by reference.

### BACKGROUND OF THE INVENTION

Conventional electronic computing systems encode logic and computation within manufactured topology, including transistors, wires, and logic gates. Similarly, most photonic computing systems encode computation within etched waveguides, routing networks, and predefined ports.

This reliance on stored topology imposes escalating fabrication complexity, cost, rigidity, and scaling limitations. Scaling requires increasingly precise lithography, growing capital investment, and complex design workflows.

Even emerging photonic approaches typically preserve the assumption that computation must be routed through fixed paths and decoded at predefined endpoints.

There exists a need for a computing architecture in which computation is not embedded in stored topology, and in which scaling is decoupled from fabricated routing structures.

### BRIEF SUMMARY OF THE INVENTION

The present invention provides a computing system in which information processing arises from transient physical field evolution within a physical medium lacking stored routing topology.

The medium does not encode logic, routing, or computational paths. Instead, computation emerges dynamically from the interaction of an input field with the physical properties and boundary conditions of the medium.

Computational paths exist only while the field propagates and are not retained after propagation ceases. Identical input conditions produce repeatable resulting field states, subject to physical measurement limits.

The invention further provides methods for decoding computation by measuring resulting field states, distributions, or patterns without reliance on predefined output ports or terminal endpoints.

In a preferred embodiment, the physical field comprises an optical field. However, the invention is not limited to optical implementations, and other physical fields may be employed consistent with the disclosed architecture.

### BRIEF DESCRIPTION OF THE DRAWINGS

No drawings are included in this application, as the invention can be understood without them.

### DETAILED DESCRIPTION OF THE INVENTION

As used herein, the term ‘stored topology’ refers to fabricated physical structures that encode routing, logic, or computational function prior to operation.

The term ‘transient field evolution’ refers to physical field behavior that exists only during propagation and is not retained as state.

The term ‘decoding’ refers to the process of determining computational output by measurement and interpretation of resulting field states.

The term ‘discretization’ refers to the assignment of decoded field information to symbolic, classified, or decision-based outputs and does not define the computation itself.

In one embodiment, a physical field is introduced into a physical medium that lacks stored routing topology. The medium provides boundary conditions and physical constraints but does not encode computational structure.

The field evolves according to physical laws, producing dynamic field distributions that represent computation.

No internal routing paths, waveguides, logic elements, or predefined ports are required. Computational behavior is determined solely by input conditions and physical interaction with the medium.

Computational behavior may be programmed by variation of input field parameters including, but not limited to, angle, phase, polarization, amplitude, spatial profile, timing, or combinations thereof, while the physical medium remains unchanged.

Decoding may be performed through observation and measurement of resulting field states during transient field evolution, at the conclusion of field evolution, or any combination thereof.

Measurement may include, but is not limited to, spatial, temporal, polarization-based, spectral, interferometric, correlation-based, or intensity-based observation, and decoding mechanisms are not limited to any specific sensor or measurement technology.

Discretization or classification of decoded outputs, if performed, occurs external to the physical medium and does not impose stored routing, logic, or computational structure within the medium.

Computational capacity is influenced by the physical extent of the medium and the fidelity with which resulting field states are measured and interpreted, rather than by fabricated routing density.

Measurement fidelity may include, but is not limited to, spatial resolution, intensity resolution, polarization sensitivity, temporal resolution, noise characteristics, repeatability, and combinations thereof.

Practical limits on system behavior arise from physical properties of the field and medium including, but not limited to, coherence length or coherence time, material loss, dispersion, scattering, environmental stability, and noise. These factors limit field evolution without creating stored topology.

In one non-limiting example, an optical field is introduced into a bulk medium lacking waveguides, and resulting field distributions are observed on a sensor. Different input configurations yield different repeatable output patterns.

1. A computing system comprising: a physical medium lacking stored routing topology; an input configured to introduce a physical field into the medium; wherein computation arises from transient field evolution governed by physical laws rather than fabricated paths, routing, or stored topology; and a decoder configured to determine output by observation and measurement of resulting field states without reliance on predefined output ports.

2. The system of claim 1, wherein computational behavior is reprogrammed by modifying one or more input field parameters without modifying the physical medium.

3. The system of claim 1, wherein the decoder is configured to observe resulting field states during transient field evolution, at the conclusion of field evolution, or any combination thereof.

4. The system of claim 1, wherein decoding is performed using one or more measurement modalities including, but not limited to, spatial, temporal, polarization-based, spectral, interferometric, correlation-based, or intensity-based observation.

5. The system of claim 1, wherein discretization or classification of decoded outputs, if performed, is external to the physical medium and does not impose stored routing, logic, or computational structure within the medium.

6. A method of computation comprising introducing a physical field into a physical medium lacking stored routing topology, allowing the field to evolve transiently according to physical laws, and decoding computation by observing and measuring resulting field states without reliance on predefined output ports.
